(19) United States
(12) Patent Application Publication
(10) Pub. No.: US 2026/0200421 A1
(43) Pub. Date: Jul. 16, 2026

(54) SEMICONDUCTOR DEVICE, POWER SUPPLY SYSTEM, AND VEHICLE

(71) Applicant: ROHM CO., LTD., Kyoto (JP)

(72) Inventor: Yuki TERAMAE, Kyoto (JP)

(21) Appl. No.: 19/445,046

(22) Filed: Jan. 9, 2026

(30) Foreign Application Priority Data
Jan. 16, 2025 (JP) 2025-006175

(51) Int. Cl. B60R 16/03

(52) U.S. Cl. CPC B60R 16/0315

(57) ABSTRACT

A semiconductor device includes: a multi-channel power supply circuit; a first input terminal configured to receive an enable signal; and a controller configured to control a first power supply circuit included in the multi-channel power supply circuit to start up and shut down in accordance with the enable signal, and to control a second power supply circuit included in the multi-channel power supply circuit to maintain an output-on state after startup irrespective of the enable signal.

### CROSS-REFERENCE TO RELATED APPLICATION

This application is based upon and claims the benefit of priority from Japanese Patent Application No. 2025-006175, filed on January 16, 2025, the entire contents of which are incorporated herein by reference.

### TECHNICAL FIELD

The present disclosure relates to a semiconductor device.

### BACKGROUND

In the related art, a power management IC (PMIC) equipped with power supply circuits for multiple channels is known.

### BRIEF DESCRIPTION OF DRAWINGS

The accompanying drawings, which are incorporated in and constitute a part of the specification, illustrate embodiments of the present disclosure.

FIG. 1 is a block diagram showing a configuration of a semiconductor device according to an exemplary embodiment of the present disclosure.

FIG. 2 is a plan view of a semiconductor device as viewed from above.

FIG. 3 is a diagram showing a register map to set a delay time for determining startup timing.

FIG. 4 is a diagram showing a register map to set a delay time for determining shutdown timing.

FIG. 5 is a diagram showing a register map for setting an always-on function and the like.

FIG. 6 is a timing chart showing an example of an operation of startup/shutdown control in a semiconductor device.

FIG. 7 is a diagram showing an example of a configuration of a power supply system using a semiconductor device.

FIG. 8 is a timing chart showing an example of an operation of a power supply system.

FIG. 9 is a diagram showing another example of a configuration of a power supply system using a semiconductor device.

FIG. 10 is a diagram showing an example of a configuration of a vehicle equipped with a semiconductor device.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Exemplary embodiments of the present disclosure will be described below with reference to the drawings.

### PMIC Configuration

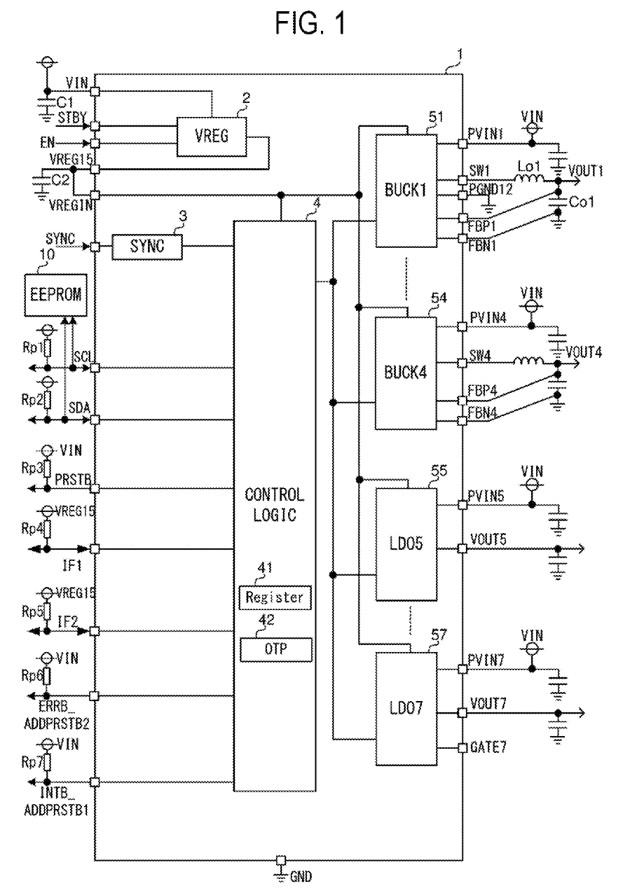

FIG. 1 is a block diagram showing a configuration of a semiconductor device 1 according to an exemplary embodiment of the present disclosure. The semiconductor device 1 is constituted as a PMIC. The semiconductor device 1 includes multi-channel power supply circuits (BUCK1 to BUCK4 and LDO5 to LDO7), as will be described below.

The semiconductor device 1 includes, as external terminals for establishing electrical connections with an outside, a VIN terminal, a STBY terminal, an EN terminal, a VREG15 terminal, a VREGIN terminal, a SYNC terminal, an SCL terminal, an SDA terminal, a PRSTB terminal, an IF1 terminal, an IF2 terminal, an ERRB_ADDPRSTB2 terminal, an INTB_ADDPRSTB1 terminal, and a GND terminal.

The semiconductor device 1 includes, as its internal components, an internal power supply circuit 2, a SYNC circuit 3, a controller (control logic) 4, buck power supply circuits 51 to 54, and low drop out (LDO) circuits 55 to 57. The semiconductor device 1 includes the above-described internal components integrated on a single chip. Specifically, the semiconductor device 1 includes a total of seven channels of power supply circuits: four channels of buck power supply circuits and three channels of LDO circuits.

The semiconductor device 1 also includes, as external terminals corresponding to the buck power supply circuits 51 to 54, PVIN1 to PVIN4 terminals, SW1 to SW4 terminals, FBP1 to FBP4 terminals, and FBN1 to FBN4 terminals. An external PGND12 terminal is provided corresponding to the buck power supply circuits 51 and 52 and an external PGND34 terminal is provided corresponding to the buck power supply circuits 53 and 54.

The semiconductor device 1 also includes, as external terminals corresponding to the LDO circuits 55 to 57, PVIN5 to PVIN7 terminals and VOUT5 to VOUT7 terminals. An external GATE7 terminal is provided corresponding to the LDO circuit 57.

An input voltage VIN is applied to the VIN terminal from the outside, and a capacitor C1, which is a bypass capacitor, is externally connected between the VIN terminal and a ground.

A standby signal STBY is input to the STBY terminal from the outside. An enable signal EN is input to the EN terminal from the outside. The enable signal EN can have a high level or a low level.

The internal power supply circuit 2 generates an internal power supply voltage VREG15 based on the input voltage VIN. The internal power supply voltage VREG15 is a voltage of 1.5 V and is used as a power supply voltage within the IC and output from the VREG15 terminal. A bypass capacitor C2 is connected between the VREG15 terminal and the ground. The internal power supply voltage VREG15 is input to the VREGIN terminal and supplied to the controller 4 and each of the power supply circuits 51 to 57.

The SYNC terminal is a terminal used for the SYNC (synchronization) function. An external clock signal is input to the SYNC terminal, and switching cycles of the buck power supply circuits 51 to 54 are synchronized to the external clock signal.

The SCL terminal and the SDA terminal are provided for I²C (Inter-Integrated Circuit) communication. I²C is a type of serial communication protocol. A clock signal SCL is transmitted and received between the SCL terminal and an external device, and a data signal SDA is transmitted and received between the SDA terminal and an external device. The external device includes an electrically erasable programmable read-only memory (EEPROM) 10. The SCL terminal and the SDA terminal are pulled up by pull-up resistors Rp1 and Rp2, respectively. The serial communication is not limited to I²C and may, for example, use a serial peripheral interface (SPI) or the like.

The PRSTB (power-on reset) terminal is a terminal for outputting a reset signal PRSTB and is pulled up by a pull-up resistor Rp3. The reset signal PRSTB is an open-drain signal that indicates active (reset state) at a low level.

The IF1 terminal and the IF2 terminal are terminals for communication between the semiconductor device 1 and an external PMIC. The IF1 terminal and the IF2 terminal are pulled up by pull-up resistors Rp4 and Rp5, respectively.

The ERRB_ADDPRSTB2 terminal is a terminal shared by both an error notification function and a second additional power-on reset function. The ERRB_ADDPRSTB2 terminal allows the second additional power-on reset function to be added without increasing the number of terminals. The second additional power-on reset function and the first additional power-on reset function to be described below are functions added to the power-on reset function that uses the reset signal PRSTB. When the error notification function is enabled, an error signal is output from the ERRB_ADDPRSTB2 terminal. When the second additional power-on reset function is enabled, an additional reset signal ADD_PRSTB2 is output from the ERRB_ADDPRSTB2 terminal. Which of the error notification function and the second additional power-on reset function is to be enabled is set in a register 41. The ERRB_ADDPRSTB2 terminal is pulled up by a pull-up resistor Rp6. The ERRB_ADDPRSTB2 terminal is active at a low level due to its open drain.

The INTB_ADDPRSTB1 terminal is a terminal shared by both the interrupt function and the first additional power-on reset function. The INTB_ADDPRSTB1 terminal allows the first additional power-on reset function to be added without increasing the number of terminals. When the interrupt function is enabled, an interrupt signal is output from the INTB_ADDPRSTB1 terminal. When the first additional power-on reset function is enabled, an additional reset signal ADD_PRSTB1 is output from the INTB_ADDPRSTB1 terminal. Which of the interrupt function and the first additional power-on reset function is to be enabled is set in the register 41. The INTB_ADD PRSTB1 terminal is pulled up by a pull-up resistor Rp7. The INTB_ADD PRSTB1 terminal is active at a low level due to its open drain.

Next, the buck power supply circuits will be described. Here, the buck power supply circuit 51 will be described as a representative example. The buck power supply circuit 51 includes a half-bridge constituted by a high-side switch and a low-side switch (neither shown), and a control circuit (not shown) configured to drive and control the high-side switch and the low-side switch. The buck power supply circuit 51, an inductor Lo1, and an output capacitor Co1 constitute a DC/DC converter (switching regulator) configured to step down the input voltage VIN to generate an output voltage VOUT1.

The input voltage VIN is input to the PVIN1 terminal from the outside. A ground potential is applied to the PGND12 terminal. Here, as an example, the high-side switch is constituted by a P-channel MOSFET, and the low-side switch is constituted by an N-channel MOSFET. A source of the high-side switch is connected to a PVIN terminal, a drain of the high-side switch is connected to a drain of the low-side switch, and a source of the low-side switch is connected to the PGND12 terminal. That is, the high-side switch and the low-side switch are connected between the PVIN terminal and the PGND12 terminal. A node at which the drain of the high-side switch and the drain of the low-side switch are connected is connected to the SW1 terminal. One end of the inductor Lo1 is externally connected to the SW1 terminal. The other end of the inductor Lo1 is connected to one end of the output capacitor Co1. The other end of the output capacitor Co1 is connected to the ground. The one end of the output capacitor Co1 is connected to the FBP1 terminal, and the other end of the output capacitor Co1 is connected to the FBN1 terminal. A voltage between the FBP1 terminal and the FBN1 terminal is input as a feedback voltage to the buck power supply circuit 51, and the control circuit performs a feedback control so that the output voltage VOUT1 becomes a target voltage. The ground applied to the PGND12 terminal is shared by the buck power supply circuits 51 and 52, and the ground applied to the PGND34 terminal is shared by the buck power supply circuits 53 and 54.

Next, the LDO circuits will be described. Here, the LDO circuit 55 will be described as a representative example. The LDO circuit 55 includes an output transistor (not shown) and a control circuit (not shown) configured to drive and control the output transistor. The LDO circuit 55 is a DC/DC converter (series regulator) configured to step down the input voltage VIN to generate an output voltage VOUT5. The output transistor is constituted by a P-channel MOSFET.

The input voltage VIN is input to the PVIN5 terminal from the outside. The PVIN5 terminal is connected to a source of the output transistor. A VOUT5 terminal is connected to a drain of the output transistor. The output voltage VOUT5 generated at the VOUT5 terminal is fed back to the control circuit where the feedback control is performed so that the output voltage VOUT5 becomes the target voltage.

The GATE7 terminal is a terminal for driving a gate of an external output transistor when the external output transistor is used for the LDO circuit 57.

### Layout of External Terminals

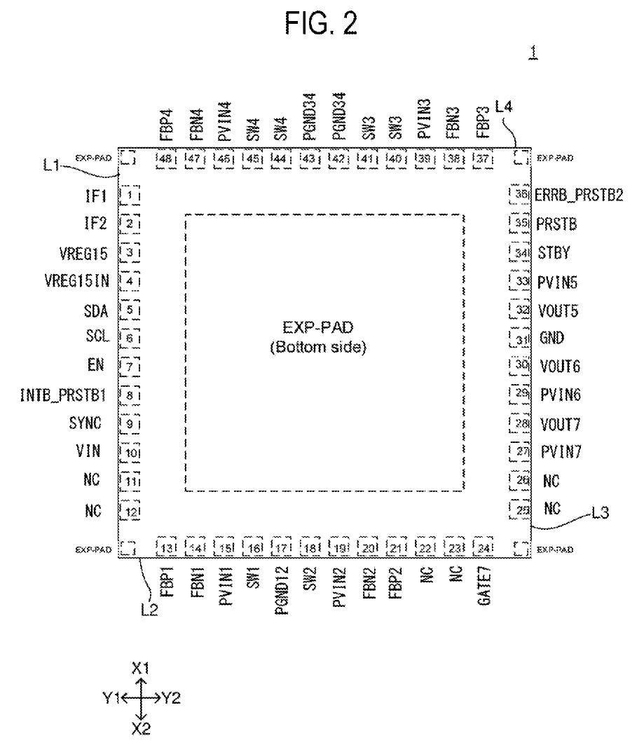

FIG. 2 is a plan view of the semiconductor device 1 as viewed from above. FIG. 2 shows a layout of the external terminals (pin numbers 1 to 48). In FIG. 2, a first direction X (vertical direction on the page) is indicated by one side X1 and the other side X2 in the first direction, and a second direction Y (horizontal direction on the page) is indicated by one side Y1 and the other side Y2 in the second direction.

The semiconductor device 1 has a rectangular shape when viewed from above, and has a first side L1, a second side L2, a third side L3, and a fourth side L4. The first side L1 and the third side L3 extend in the first direction, and the second side L2 and the fourth side L4 extend in the second direction. The first side L1 and the third side L3 face each other in the second direction, and the second side L2 and the fourth side L4 face each other in the first direction. The other end of the first side L1 in the first direction is connected to the one end of the second side L2 in the second direction. The other end of the second side L2 in the second direction is connected to the other end of the third side L3 in the first direction. The one end of the third side L3 in the first direction is connected to the other end of the fourth side L4 in the second direction. The one end of the fourth side L4 in the second direction is connected to the one end of the first side L1 in the first direction.

The IF1 terminal, the IF2 terminal, the VREG15 terminal, a VREG15IN terminal, the SDA terminal, the SCL terminal, the EN terminal, an INT_BPRSTB1 terminal, the SYNC terminal, the VIN terminal, an NC (non-connect) terminal, and an NC terminal are sequentially arranged along the first side L1 from one side in the first direction.

The FBP1 terminal, the FBN1 terminal, the PVIN1 terminal, the SW1 terminal, the PGND12 terminal, the SW2 terminal, the PVIN2 terminal, the FBN2 terminal, the FBP2 terminal, the NC terminal, the NC terminal, and the GATE7 terminal are sequentially arranged along the second side L2 from one side in the second direction.

The NC terminal, the NC terminal, the PVIN7 terminal, the VOUT7 terminal, the PVIN6 terminal, the VOUT6 terminal, the GND terminal, the VOUT5 terminal, the PVIN5 terminal, the STBY terminal, the PRSTB terminal, and an ERRB_PRSTB2 terminal are sequentially arranged along the third side L3 from the other side in the first direction.

The FBP3 terminal, the FBN3 terminal, the PVIN3 terminal, the SW3 terminal, the SW3 terminal, the PGND34 terminal, the PGND34 terminal, the SW4 terminal, the SW4 terminal, the PVIN4 terminal, the FBN4 terminal, and the FBP4 terminal are sequentially arranged along the fourth edge L4 from the other side in the second direction.

Heat dissipation pads (EXP-PAD) are arranged on a bottom surface of the semiconductor device 1 and at four corners of the rectangle.

### Normal Control of Startup/Shutdown

Next, a normal control of startup/shutdown of the semiconductor device 1 will be described. In the normal control, the startup timing (timing at which the output voltage starts to rise) and the shutdown timing (timing at which the output voltage starts to fall) of each of the buck power supply circuits 51 to 54 and the LDO circuits 55 to 57 are controlled based on the enable signal EN. The startup/shutdown control is performed by the controller 4. Here, a register map in the register 41 for setting related to the startup timing control and the shutdown timing control will be described.

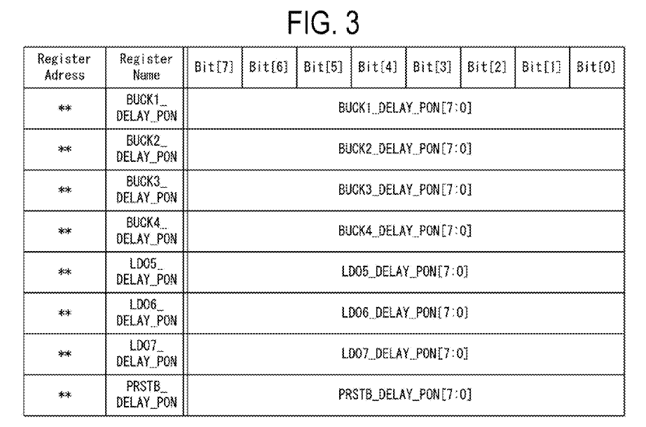

FIG. 3 is a diagram showing a register map used to set a delay time for determining the startup timing. The register maps shown in FIG. 3 and subsequent figures show register addresses, data names (register names), and setting data. The setting data are, for example, 8-bit data (Bit[7] to Bit[0]). The delay time set here is a delay time from when the enable signal EN rises.

BUCK1_DELAY_PON through BUCK4_DELAY_PON are data used to set the delay time for each of the buck power supply circuits 51 to 54. LDO5_DELAY_PON through LDO7_DELAY_PON are data used to set the delay times for the LDO circuits 55 to 57, respectively. PRSTB_DELAY_PON is data used to set the delay time for the reset signal PRSTB.

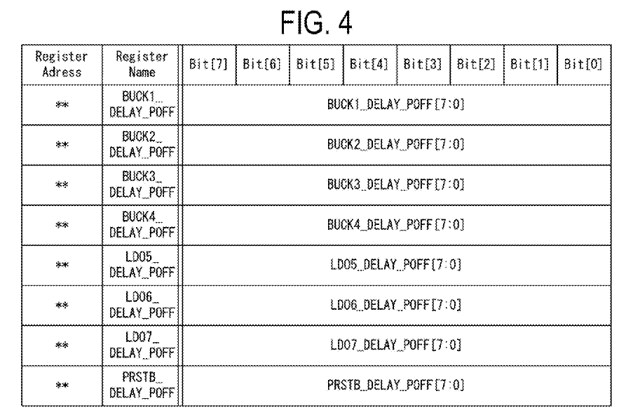

FIG. 4 is a diagram showing a register map used to set a delay time for determining the shutdown timing. The delay time that is set here is a delay time from when the enable signal EN falls.

BUCK1_DELAY_POFF through BUCK4_DELAY_POFF are data used to set the delay time for the buck power supply circuits 51 to 54, respectively. LDO5_DELAY_POFF through LDO7_DELAY_POFF are data used to set the delay time for the LDO circuits 55 to 57, respectively. PRSTB_DELAY_POFF is data used to set the delay time for the reset signal PRSTB.

The setting data of the register maps shown in FIGS. 3 and 4 are set, for example, as follows:

when the setting data = 0x00, the delay time = 2 μs;

when the setting data = 0x01 to 0x80, the delay time = 128 μs to 16.384 ms (step = 128 μs);

when the setting data = 0x80 to 0xA0, the delay time = 16.384 ms to 24.576 ms (step = 256 μs);

when the setting data = 0xA0 to 0xC0, the delay time = 24.576 ms to 40.960 ms (step = 512 μs);

when the setting data = 0xC0 to 0xE0, the delay time = 40.960 μs to 73.728 ms (step = 1.024 ms); and

when the setting data = 0xE0 to 0xFF, the delay time = 73.728 μs to 137.216 ms (step = 2.048 ms).

As shown, the longer the delay time is, the longer the step is. This makes it possible to suppress an increase in the number of bits of the setting data, while setting the delay time in a range as wide as possible.

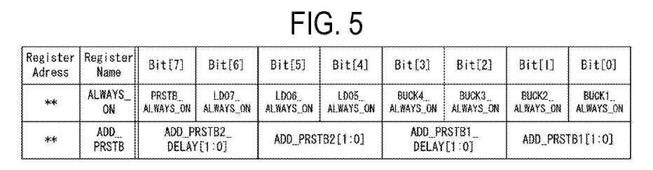

An upper portion of FIG. 5 shows a register map used to set whether or not the always-on function (ALWAYS_ON) is enabled for each channel. The always-on function is a function that allows the channel output to be in an on state (a state in which an output voltage is output) at all times after the channel starts up, regardless of the enable signal EN, and is distinct from the normal control described above.

BUCK1_ALWAYS_ON through BUCK4_ALWAYS_ON are data (1-bit data) used to set which of the normal control and the always-on function is enabled for the buck power supply circuits 51 to 54, respectively. LDO5_ALWAYS_ON through LDO7_ALWAYS_ON are data (1-bit data) used to set which of the normal control and the always-on function is enabled for the LDO circuits 55 to 57, respectively.

PRSTB_ALWAYS_ON is data (1-bit data) used to set which of the normal control or the always-on function is enabled for the reset signal.

For example, in each bit data, "0" enables the normal control, and "1" enables the always-on function. Details of the always-on function will be described later.

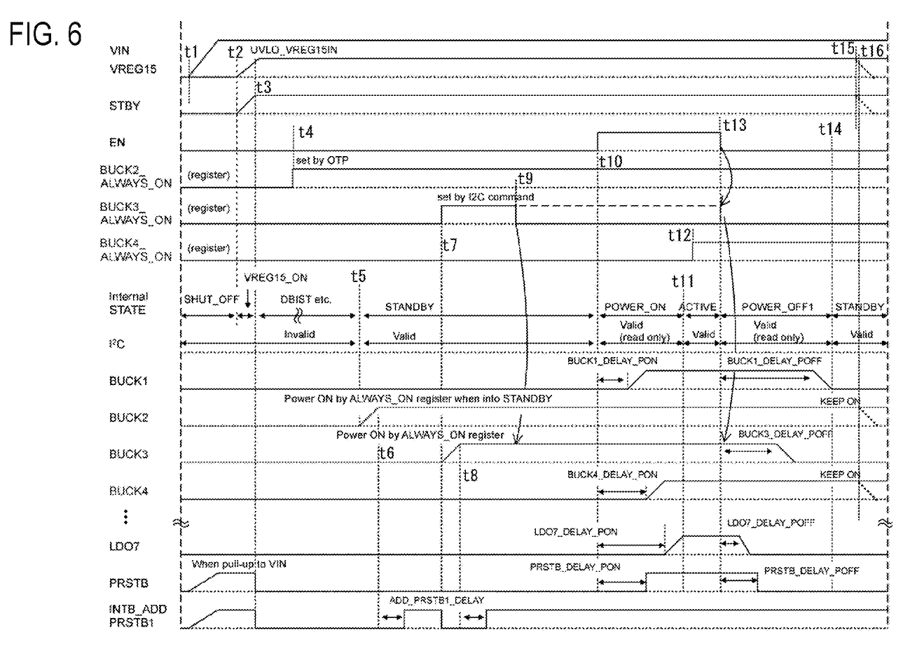

Next, an example of the operation of the normal control of startup/shutdown will be described with reference to FIG. 6. FIG. 6 is a timing chart showing an example of the operation of startup/shutdown control in the semiconductor device 1. In FIG. 6, the input voltage VIN, the internal power supply voltage VREG15, the standby signal STBY, and the enable signal EN are shown from top to bottom. Next, the setting values of BUCK2_ALWAYS_ON, BUCK3_ALWAYS_ON, and BUCK4_ALWAYS_ON (FIG. 5) are shown. Next, an internal state, the I²C communication state, the output voltages corresponding to the buck power supply circuits 51 to 54 (BUCK1 to BUCK4), and the output voltages corresponding to the LDO circuits 55 to 57 (LDO5 to LDO7) are shown. The reset signal PRSTB and the additional reset signal ADD_PRSTB1 shown at the bottom of FIG. 6 will be described later.

At timing t1, the input voltage VIN starts to rise. Then, when the standby signal STBY rises (switches to an on state) at timing t2, the internal power supply circuit 2 starts up, and the internal power supply voltage VREG15 starts to rise. At timing t3, an under voltage lock out (UVLO) of the internal power supply voltage VREG15 is released. The internal state is a shut-off state until timing t2, and VREG15 is in an on state from timing t2 to t3.

After timing t3, the internal state transitions to a digital built-in self-test (BIST) and the like for the controller 4. Specifically, the transition is made in the order of digital BIST (DBIST), one time programmable ROM (OTP) read state, EEPROM read state, and analog BIST for various protection circuits.

Thereafter, at timing t5, the internal state transitions to a standby state. Then, at timing t10, the enable signal EN rises (switches to a level indicating startup).

In the example of FIG. 6, the register map shown in FIG. 5 sets the normal control to be enabled for the buck power supply circuit 51 (BCU K1) and LDO circuits 55 to 57 (LDO5 to 7). As a result, the buck power supply circuit 51 and the LDO circuits 55 to 57 are started up at timings at which the delay times (BUCK1_DELAY_PON and LDO5_DELAY_PON through LDO7_DELAY_PON) set by the register map shown in FIG. 3 have elapsed since timing 10 (the rising edge of the enable signal EN), as startup timings. The output voltages start to rise at these startup timings.

Thereafter, at timing t13, the enable signal EN falls (switches to a level indicating shutdown). As a result, the buck power supply circuit 51 and the LDO circuits 55 to 57 shut down at timings at which the delay times (BUCK1_DELAY_POFF and LDO5_DELAY_POFF through LDO7_DELAY_POFF) set by the register map shown in FIG. 4 have elapsed since timing 13, as shutdown timings. The output voltages start to fall at these shutdown timings.

In this way, for the channels for which the normal control is enabled, the startup/shutdown control is possible in accordance with the enable signal EN.

### Always-On Function

Next, the operation by the always-on function will be described with reference to FIG. 6.

When the internal state is the OTP read state, data is read from an OTP 42 (FIG. 1) included in the controller 4. The OTP is a non-volatile memory that can be written only once. Further, when the internal state is the EEPROM read state, data is read from an EEPROM 10. The EEPROM is a type of non-volatile memory.

The data read from the OTP or EEPROM can be written to enable the always-on function in the register map shown in FIG. 5. The channels for which the always-on function is enabled are started up at a timing at which the internal state transitions to the standby state. In the example of FIG. 6, BUCK2_ALWAYS_ON is written in the register map at timing t4 to enable the always-on function for the buck power supply circuit 52 (BUCK2), and therefore the buck power supply circuit 52 is started up at timing t5 at which the internal state transitions to the standby state.

Further, the data can be written to set the always-on function to be enabled in the register map shown in FIG. 5 from the outside of the semiconductor device 1 using I²C communication. However, the writing of data in the register 41 using I²C communication is only possible when the internal state is the standby state (STANBY in FIG. 6) or active state (ACTIVE in FIG. 6). The active state is transitioned from the power-on state (POWER_ON in FIG. 6) from when the enable signal EN rises until the last channel has completed the startup under the normal control.

When the internal state is the standby state, a channel for which the data is written to set the always-on function to be enabled in the register map using I²C communication is started up at that timing. For example, in the example of FIG. 6, BUCK3_ALWAYS_ON is written in the register map at timing t7 to enable the always-on function for the buck power supply circuit 53 (BUCK3), and therefore the buck power supply circuit 53 is started up at timing t7.

For the channels for which the always-on function is set to be enabled, the output remains in the on state even in a case where the enable signal EN falls, unless the following shutdown conditions are met. The shutdown conditions are met for either of the following:

(1) the standby signal STBY is set to an OFF state, or

(2) data is written in the register 41 using I²C communication to set the always-on function to be disabled, and the enable signal EN falls.

However, in a case where the above condition (2) is met, shutdown occurs at a timing at which the delay time set for the target channel by the register map shown in FIG. 4 has elapsed after the enable signal EN falls.

In the example of FIG. 6, for the buck power supply circuit 52 (BUCK2) in which the always-on function is set to be enabled, the above shutdown conditions are not met, and therefore the output remains in the on state even at time t13 at which the enable signal EN falls.

Furthermore, for the buck power supply circuit 53 (BUCK3) in which the always-on function is set to be enabled, BUCK3_ALWAYS_ON in the register map is written to disable the always-on function at timing t9 (standby state) or timing t13 (active state), and the enable signal EN falls at timing t13, and therefore shutdown occurs at timing t13. In other words, even in a case where the data is written in the register 41 to disable the always-on function before at a timing at which the enable signal EN falls, shutdown does not occur at that timing; rather, shutdown occurs in a sequence based on the enable signal EN.

In a case where the channel for which the normal control is set to be enabled is started up when the enable signal EN rises, when the data is written in the register 41 using I²C communication to set the always-on function to be enabled for that channel when the internal state is the active state, the output remains in the on state even when the enable signal EN falls, as long as the shutdown conditions are not met. For example, in the example of FIG. 6, the buck power supply circuit 54 (BUCK4) for which the normal control is set to be enabled is started up when the enable signal EN rises at timing t10. Then, at timing t12 in the active state, BUCK4_ALWAYS_ON is written in the register map to enable the always-on function. Therefore, the output remains in the on state even in a case where the enable signal EN falls at timing t13.

The example in FIG. 6 shows a case where the standby signal STBY falls to the off state at timing t15 (the above condition (1)), the internal power supply circuit 2 is shut down, and the internal power supply voltage VREG15 falls. As a result, UVLO is detected at timing t16, and the buck power supply circuits 52 and 54 (BUCK2 and BUCK4) are shut down.

The shutdown due to the above shutdown conditions (1) and (2) is a shutdown under the normal operation, and for the channel for which the always-on function is set to be enabled, shutdown also occurs even in a case where a specific protection circuit for that channel detects an abnormality. The specific protection circuit is, for example, over voltage protection (OVP), under voltage protection (UVP), and UVLO protection circuits for the PVIN terminal provided in the buck power supply circuits 51 to 54 and the LDO circuits 55 to 57, respectively.

In this way, in the present embodiment, by enabling the always-on function, the output can remain in the on state even in a case where the enable signal EN falls after startup, making it possible to accommodate specifications of various targets to which the output voltage is supplied.

### Reset Signal

Next, the reset signal for power-on reset will be described.

For the reset signal PRSTB, which of the normal control and the always-on function is to be enabled can be set using PRSTB_ALWAYS_ON in the register map shown in FIG. 5. When the normal control is set to be enabled for the reset signal PRSTB, the reset signal PRSTB behaves based on the enable signal EN. Specifically, the reset signal PRSTB transitions to a reset release state (high level) at a timing at which the delay time set by PRSTB_DELAY_PON in the register map shown in FIG. 3 has elapsed from the rising edge of the enable signal EN, and transitions to a reset state (low level) at a timing at which the delay time set by PRSTB_DELAY_POFF in the register map shown in FIG. 4 has elapsed from the falling edge of the enable signal EN.

In the example of FIG. 6, the normal control of the reset signal PRSTB is set to be enabled, and the reset signal PRSTB transitions to the reset release state after the delay time set by PRSTB_DELAY_PON has elapsed from timing t10 at which the enable signal EN rises, and transitions to the reset state after the delay time set by PRSTB_DELAY_POFF has elapsed from timing t13 at which the enable signal EN falls.

On the other hand, when the always-on function is set to be enabled for the reset signal PRSTB, the reset signal PRSTB transitions to the reset release state at a timing at which the delay time set by PRSTB_DELAY_PON has elapsed from a timing at which the enable signal EN rises, and the reset release state continues even when the enable signal EN falls.

Next, the additional power-on reset function will be described. In the register map shown in FIG. 5, "ADD_PRSTB" indicates the setting data for the additional power-on reset function.

ADD_PRSTB1, which is stored in the first and second least significant bits, is data used to set whether the first additional power-on reset function is enabled or disabled. Specifically, for example, when ADD_PRSTB1 = 00, the first additional power-on reset function is disabled, i.e., the interrupt function is enabled. When ADD_PRSTB1 = 01, the always-on function is enabled for the first additional power-on reset function.

ADD_PRSTB1_DELAY, which is stored in the third and fourth least significant bits, is data to set the delay time for the first additional power-on reset function. When the first additional power-on reset function is enabled as the always-on function, then while the internal state is the standby state, each time start-up of a channel for which the always-on function is enabled is completed, the additional reset signal ADD_PRSTB1 transitions to the reset release state (high level) at a timing at which the delay time set by ADD_PRSTB1_DELAY has elapsed. Furthermore, in the standby state, each time a channel for which the always-on function is enabled is started up, the additional reset signal ADD_PRSTB1 transitions to the reset state (low level). Then, the additional reset signal ADD_PRSTB1 remains in the reset release state even when the enable signal EN falls.

In the example of FIG. 6, since the first additional power-on reset function is enabled as the always-on function, the additional reset signal ADD_PRSTB1 transitions to the reset release state with a delay from the startup completion timing t6 of the buck power supply circuit 52 (BUCK2) for which the always-on function is set to be enabled. Then, the additional reset signal ADD_PRSTB1 transitions to the reset state at the startup timing t7 of the buck power supply circuit 53 (BUCK3) for which the always-on function is set to be enabled. Then, the additional reset signal ADD_PRSTB1 transitions to the reset release state with a delay from the startup completion timing t8 of the buck power supply circuit 53. Then, the additional reset signal ADD_PRSTB1 remains in the reset release state even at timing t13 at which the enable signal EN falls.

ADD_PRSTB2 and ADD_PRSTB2_DELAY in the register map shown in FIG. 5 are data used to set the second additional power-on reset function, and are the same as the first additional power-on reset function described above, so detailed description thereof will be omitted.

ADD_PRSTB1_DELAY and ADD_PRSTB2_DELAY are set, for example, as follows:

When ADD_PRSTB1_DELAY or ADD_PRSTB2_DELAY = 00, the delay time is 2 μs;

When ADD_PRSTB1_DELAY or ADD_PRSTB2_DELAY = 01, the delay time is 1.211 ms;

When ADD_PRSTB1_DELAY or ADD_PRSTB2_DELAY = 10, the delay time is 4.845 ms; and

When ADD_PRSTB1_DELAY or ADD_PRSTB2_DELAY = 11, the delay time is 9.690 ms.

### Power Supply System

Next, an example of the configuration of a power supply system (also called a power tree) using the semiconductor device 1 according to the embodiment of the present disclosure as described above will be described.

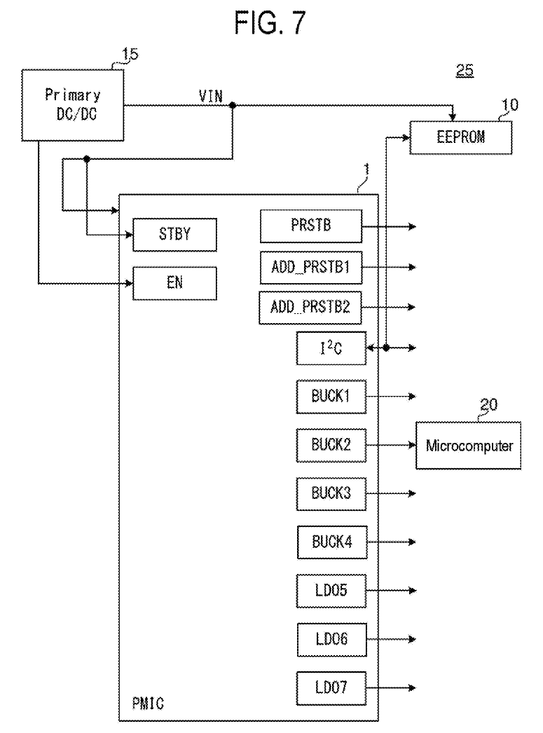

FIG. 7 is a diagram showing the configuration of a power supply system 25 using the semiconductor device 1. The power supply system 25 includes a semiconductor device 1, an EEPROM 10, a primary DC/DC converter 15, and a microcomputer 20.

The primary DC/DC converter 15 supplies the input voltage VIN, which is generated by DC/DC conversion, to the semiconductor device 1 and the EEPROM 10. Here, the VIN terminal is short-circuited to the STBY terminal. Therefore, the input voltage VIN and the standby signal STBY are the same signal. The enable signal EN is also input from the primary DC/DC converter 15 to the semiconductor device 1. The output voltage generated by the buck power supply circuit 52 (BUCK2) in the semiconductor device 1 is supplied to the microcomputer 20.

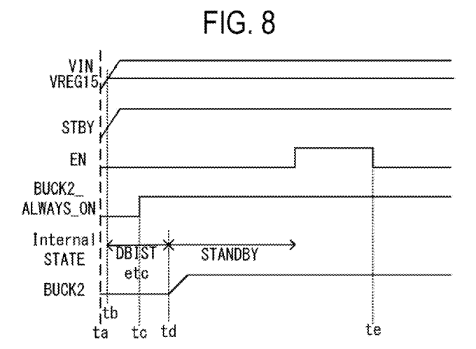

The operation of the power supply system 25 configured as described above will be described using a timing chart shown in FIG. 8. FIG. 8 shows, from top to bottom, the input voltage VIN, the internal power supply voltage VREG15, the standby signal STBY, the enable signal EN, the BUCK2_ALWAYS_ON setting value, the internal state, and the output voltage of the buck power supply circuit 52.

First, at timing ta, the input voltage VIN is started up, and the standby signal STBY is started up accordingly. This is because the VIN terminal and the STBY terminal are short-circuited as described above. As a result, the internal power supply voltage VREG15 rises, UVLO is released at timing tb, and the system transitions to DBIST or the like. Here, based on the data read from the OTP42, BUCK2_ALWAYS_ON in the register 41 is written so that the always-on function is enabled (timing tc). Therefore, at timing td at which the system transitions to the standby state, the buck power supply circuit 52 is started up. Thus, even at timing te at which the enable signal EN falls, the buck power supply circuit 52 can continue keeping its output in the on state.

In this way, since the standby signal STBY can be started up simultaneously with the startup of the input voltage VIN, the UVLO of VREG 15 is released earlier, allowing the buck power supply circuit 52, which supplies the output voltage to the microcomputer 20, to be started up earlier. Furthermore, since the transition to the standby state is faster, the startup of channel by writing to enable the always-on function in the register 41 using I²C communication can also be performed earlier.

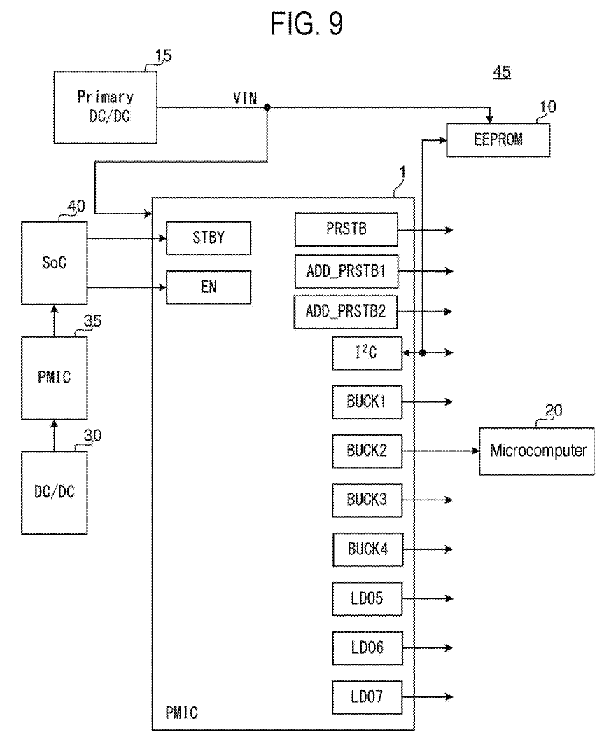

FIG. 9 is a diagram showing another example of the configuration of the power supply system using the semiconductor device 1. A power supply system 45 shown in FIG. 9 includes a primary DC/DC converter 30, a PMIC 35, and an SoC 40 in addition to the above-described semiconductor device 1, primary DC/DC converter 15, and microcomputer 20.

The primary DC/DC converter 30 supplies a power supply voltage to the PMIC 35. The PMIC 35 supplies an output voltage to the SoC 40. The SoC 40 outputs the standby signal STBY and the enable signal EN to the semiconductor device 1.

According to the above configuration, after a power supply circuit in the PMIC 35 that supplies the output voltage to the SoC 40 is started up, the SoC 40 switches the standby signal STBY to the on state. Thereafter, in the semiconductor device 1, the UVLO of VREG 15 is released, and by reading the OTP 42, BUCK2_ALWAYS_ON is written so that the always-on function is enabled. Thereafter, the buck power supply circuit 52 is started up at a timing of transition to the standby state, and the output voltage is supplied to the microcomputer 20.

According to this power supply system 45, it is possible to accommodate the specifications that require the SoC 40 to be started up before the microcomputer 20.

### Vehicle

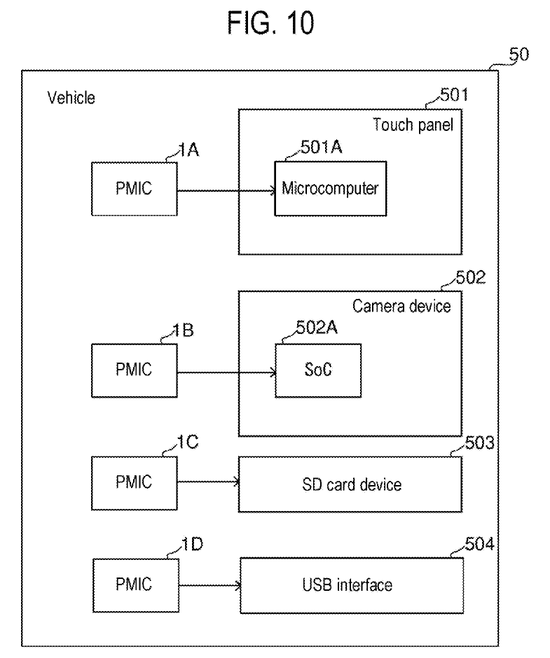

FIG. 10 is a diagram showing an example of a configuration in which the semiconductor device 1 according to the present embodiment is mounted on a vehicle. In the configuration shown in FIG. 10, the vehicle 50 is equipped with a touch panel 501, a camera device 502, an SD card device 503, and a USB interface 504. The vehicle 50 is also equipped with semiconductor devices 1A to 1D corresponding to the touch panel 501, the camera device 502, the SD card device 503, and the USB interface 504, respectively.

The touch panel 501 is provided on an in-vehicle display and is configured to be capable of operating a car navigation system, an audio system, an air conditioner, etc. The touch panel 501 is equipped with a microcomputer 501A. The semiconductor device 1A supplies an output voltage to the microcomputer 501A.

The camera device 502 is used for a drive recorder, a rearview monitor, pedestrian detection, autonomous driving, etc., and is equipped with an SoC 502A. The semiconductor device 1B supplies an output voltage to the SoC 502A.

The SD card device 503 is a device configured to read/write data from/in an SD card and receive an output voltage from the semiconductor device 1C.

The USB interface 504 is configured to be capable of being connected to a USB device such as a smartphone and receives an output voltage from the semiconductor device 1D.

Since the semiconductor devices 1A to 1D have the always-on function described above, they can be used for devices that require a constant supply of power supply voltage, such as the microcomputer 501A, the SoC 502A, the SD card device 503, and the USB interface 504.

### Others

In addition to the above-described embodiments, the various technical features disclosed in the present disclosure may be modified in various ways without departing from the spirit of the technical creation. In other words, the above-described embodiments should be considered illustrative and not restrictive in all respects. Furthermore, the technical scope of the present disclosure is not limited to the above-described embodiments, but should be understood to include all modifications that fall within the meaning and scope of equivalents of the claims.

### Supplementary Notes

As described above, a semiconductor device (1) according to one embodiment of the present disclosure has a configuration (first configuration) that it includes: a multi-channel power supply circuit (51 to 57); a first input terminal (EN terminal) configured to receive an enable signal (EN); and a controller (4) configured to control a first power supply circuit included in the multi-channel power supply circuit to start up and shut down in accordance with the enable signal, and to control a second power supply circuit included in the multi-channel power supply circuit to maintain an output-on state after startup irrespective of the enable signal.

With this configuration, it is possible to accommodate specifications of a variety of targets to which an output voltage is supplied.

In the first configuration, the semiconductor device may have a configuration (second configuration) that it further includes: a register (41) configured to be capable of setting which of a normal control and an always-on function to be enabled for each channel, wherein the controller is capable of controlling startup and shutdown for a channel for which the normal control is set to be enabled in the register, in accordance with the enable signal, and maintaining the output-on state for a channel for which the always-on function is set to be enabled in the register, without depending on the enable signal.

In the second configuration, the semiconductor device may have a configuration (third configuration) that it further includes: a non-volatile memory (42, 10), wherein when data read from the non-volatile memory is written in the register such that the always-on function is set to be enabled, the controller starts up the channel for which the always-on function is set to be enabled when transitioning to a standby state.

In the second or third configuration, the semiconductor device may have a configuration (fourth configuration) that when data is written in the register by communication from an outside of the semiconductor device such that the always-on function is set to be enabled, the controller starts up the channel for which the always-on function is set to be enabled.

In the fourth configuration, the semiconductor device may have a configuration (fifth configuration) that the writing of the data into the register by the communication from the outside is capable of being performed in either a standby state or an active state, transition to which is performed when a last started-up channel among channels for which the normal control is set to be enabled has completed startup.

In any one of the second to fifth configurations, the semiconductor device may have a configuration (sixth configuration) that after the channel for which the normal control is set to be enabled is started up in accordance with the enable signal, when the data is written into the register by the communication from the outside of the semiconductor device such that the always-on function is set to be enabled for the channel, the controller causes the channel to maintain the output-on state without depending on the enable signal.

In any one of the second to sixth configurations, the semiconductor device may have a configuration (seventh configuration) that the channel for which the always-on function is set to be enabled is shut down when one of the following conditions is met: (1) a standby signal input to the semiconductor device is in an off state; and (2) data is written in the register using the communication from the outside of the semiconductor device to set the always-on function to be disabled, and the enable signal is switched to a level indicating shutdown.

In any one of the third to fifth configurations, the semiconductor device may have a configuration (eighth configuration) that it further includes: a second input terminal (VIN terminal) configured to receive an input voltage (VIN); a third input terminal (STBY terminal) configured to receive a standby signal (STBY); and an internal power supply circuit (2) configured to generate an internal power supply voltage (VREG15), wherein when the standby signal is started up, the internal power supply circuit is started up, UVLO of the internal power supply voltage is released, and the writing of data in the register is capable of being performed, and wherein the second input terminal and the third input terminal are short-circuited.

A power supply system according to another embodiment of the present disclosure has a configuration (ninth configuration) that it includes: the semiconductor device of the eighth configuration; and a microcomputer (20) configured to supply an output voltage from the channel for which the always-on function is set to be enabled.

A power supply system according to another embodiment of the present disclosure has a configuration (tenth configuration) that it includes: the semiconductor device of any one of the first to eighth configurations; and an external device (501A, 502A, 503, 504) configured to receive an output voltage from the power supply circuit.

A vehicle according to another embodiment of the present disclosure has a configuration (eleventh configuration) that it includes: the power supply system of the ninth or tenth configuration.

### Industrial Applicability

The present disclosure can be used, for example, in power supply systems for various applications.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A semiconductor device comprising:
a multi-channel power supply circuit;
a first input terminal configured to receive an enable signal; and
a controller configured to control a first power supply circuit included in the multi-channel power supply circuit to start up and shut down in accordance with the enable signal, and to control a second power supply circuit included in the multi-channel power supply circuit to maintain an output-on state after startup irrespective of the enable signal.

2. The semiconductor device of claim 1, further comprising: a register configured to be capable of setting which of a normal control and an always-on function to be enabled for each channel,
wherein the controller is capable of controlling startup and shutdown for a channel for which the normal control is set to be enabled in the register, in accordance with the enable signal, and maintaining the output-on state for a channel for which the always-on function is set to be enabled in the register, irrespective of the enable signal.

3. The semiconductor device of claim 2, further comprising: a non-volatile memory,
wherein when data read from the non-volatile memory is written in the register such that the always-on function is set to be enabled, the controller starts up the channel for which the always-on function is set to be enabled when transitioning to a standby state.

4. The semiconductor device of claim 2, wherein when data is written in the register by communication from an outside of the semiconductor device such that the always-on function is set to be enabled, the controller starts up the channel for which the always-on function is set to be enabled.

5. The semiconductor device of claim 4, wherein the writing of the data into the register by the communication from the outside is capable of being performed in either a standby state or an active state, transition to which is performed when a last started-up channel among channels for which the normal control is set to be enabled has completed startup.

6. The semiconductor device of claim 2, wherein after the channel for which the normal control is set to be enabled is started up in accordance with the enable signal, when data is written into the register by communication from an outside of the semiconductor device such that the always-on function is set to be enabled for the channel, the controller causes the channel to maintain the output-on state irrespective of the enable signal.

7. The semiconductor device of claim 2, wherein the channel for which the always-on function is set to be enabled is shut down when one of the following conditions is met:
(1) a standby signal input to the semiconductor device is in an off state; and
(2) data is written in the register using communication from an outside of the semiconductor device to set the always-on function to be disabled, and the enable signal is switched to a level indicating shutdown.

8. The semiconductor device of claim 3, further comprising:
a second input terminal configured to receive an input voltage;
a third input terminal configured to receive a standby signal; and
an internal power supply circuit configured to generate an internal power supply voltage,
wherein when the standby signal is started up, the internal power supply circuit is started up, UVLO of the internal power supply voltage is released, and the writing of data in the register is capable of being performed, and
wherein the second input terminal and the third input terminal are short-circuited.

9. A power supply system comprising:
the semiconductor device of claim 8; and
a microcomputer configured to supply an output voltage from the channel for which the always-on function is set to be enabled.

10. A power supply system comprising:
the semiconductor device of claim 1; and
an external device configured to receive an output voltage from the power supply circuit.

11. A vehicle comprising: the power supply system of claim 10.
